(19) United States
(12) Patent Application Publication
(10) Pub. No.: US 2025/0224863 A1
(43) Pub. Date: Jul. 10, 2025

(54) ELECTRONIC DEVICE AND OPERATING METHOD THEREOF

(71) Applicant: Samsung Electronics Co., Ltd., Suwon-si (KR)

(72) Inventor: Hanchul JUNG, Suwon-si (KR)

(21) Appl. No.: 19/091,026

(22) Filed: Mar. 26, 2025

Related U.S. Application Data
(63) Continuation of application No. PCT/KR2023/012926, filed on Aug. 30, 2023.

(30) Foreign Application Priority Data
Oct. 12, 2022 (KR) 10-2022-0130206
Oct. 28, 2022 (KR) 10-2022-0141381

(51) Int. Cl. G06F 3/04845; G06F 3/04817; G06T 3/40

(52) U.S. Cl. CPC G06F 3/04845; G06F 3/04817; G06T 3/40

(57) ABSTRACT

An electronic device is provided. The electronic device includes a first display, memory storing one or more computer programs, and one or more processors communicatively coupled to the first display and the memory, wherein the one or more computer programs include computer-executable instructions that, when executed by the one or more processors individually or collectively, cause the electronic device to display a first screen of a first application on the first display, identify a designated area and a non-designated area of the first screen based on a user input on the first screen, adjust a resolution where a screen of the first application is to be displayed based on a size of the designated area and a size of the non-designated area, and display a second screen of the first application on the first display at the adjusted resolution.

### CROSS-REFERENCE TO RELATED APPLICATION(S)

This application is a continuation application, claiming priority under 35 U.S.C. § 365(c), of an International application No. PCT/KR2023/012926, filed on Aug. 30, 2023, which is based on and claims the benefit of a Korean patent application number 10-2022-0130206, filed on Oct. 12, 2022, in the Korean Intellectual Property Office, and of a Korean patent application number 10-2022-0141381, filed on Oct. 28, 2022, in the Korean Intellectual Property Office, the disclosure of each of which is incorporated by reference herein in its entirety.

### BACKGROUND

### 1. Field

The disclosure relates to an electronic device and an operation method thereof.

### 2. Description of Related Art

As electronic devices (e.g., mobile devices) are downsized, the use of small displays included in electronic devices is emerging as an important issue. Small displays have difficulty displaying sufficient content due to size limitations. Meanwhile, the execution screen of an application running on an electronic device may include a fixed user interface (UI) depending on the application's settings. When the execution screen of an application including a fixed UI is displayed on the small display of the electronic device, the size of the content area except for the fixed UI in the execution screen may decrease.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first display, memory storing one or more computer programs, and one or more processors communicatively coupled to the first display and the memory, wherein the one or more computer programs include computer-executable instructions that, when executed by the one or more processors individually or collectively, cause the electronic device to display a first screen of a first application on the first display, identify a designated area and a non-designated area on the first screen based on a user input on the first screen, adjust a resolution where a screen of the first application is to be displayed based on a size of the designated area and a size of the non-designated area, and display a second screen of the first application on the first display at the adjusted resolution.

In accordance with another aspect of the disclosure, a method performed by an electronic device is provided. The method includes displaying, by the electronic device on a first display of the electronic device, a first screen of a first application, identifying, by the electronic device, a designated area and a non-designated area on the first screen based on a user input on the first screen, adjusting, by the electronic device, a resolution where a screen of the first application is to be displayed based on a size of the designated area and a size of the non-designated area, and displaying, by the electronic device on the first display, a second screen of the first application at the adjusted resolution.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying, by the electronic device on a first display of the electronic device, a first screen of a first application, identifying, by the electronic device, a designated area and a non-designated area on the first screen based on a user input on the first screen, adjusting, by the electronic device, a resolution where a screen of the first application is to be displayed based on a size of the designated area and a size of the non-designated area, and displaying, by the electronic device on the first display, a second screen of the first application at the adjusted resolution.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a view illustrating a front surface and a rear surface of an electronic device according to an embodiment of the disclosure;

FIG. 3 is a view illustrating a folded state of an electronic device according to an embodiment of the disclosure;

FIG. 4 is a flowchart illustrating an operation method of an electronic device according to an embodiment of the disclosure;

FIG. 5 is a view illustrating operations of an electronic device according to an embodiment of the disclosure;

FIG. 6 is a view illustrating operations of an electronic device according to an embodiment of the disclosure;

FIG. 7 is a view illustrating operations of an electronic device according to an embodiment of the disclosure;

FIG. 8 is a view illustrating operations of an electronic device according to an embodiment of the disclosure;

FIG. 9 is a view illustrating operations of an electronic device according to an embodiment of the disclosure;

FIG. 10 is a flowchart illustrating an operation method of an electronic device according to an embodiment of the disclosure;

FIG. 11 is a view illustrating operations of an electronic device according to an embodiment of the disclosure;

FIG. 12 is a view illustrating operations of an electronic device according to an embodiment of the disclosure;

FIG. 13 is a view illustrating operations of an electronic device according to an embodiment of the disclosure;

FIG. 14 is a flowchart illustrating an operation method of an electronic device according to an embodiment of the disclosure;

FIG. 15 is a view illustrating operations of an electronic device according to an embodiment of the disclosure;

FIG. 16 is a flowchart illustrating an operation method of an electronic device according to an embodiment of the disclosure;

FIG. 17 is a view illustrating operations of an electronic device according to an embodiment of the disclosure; and

FIG. 18 is a flowchart illustrating an operation method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

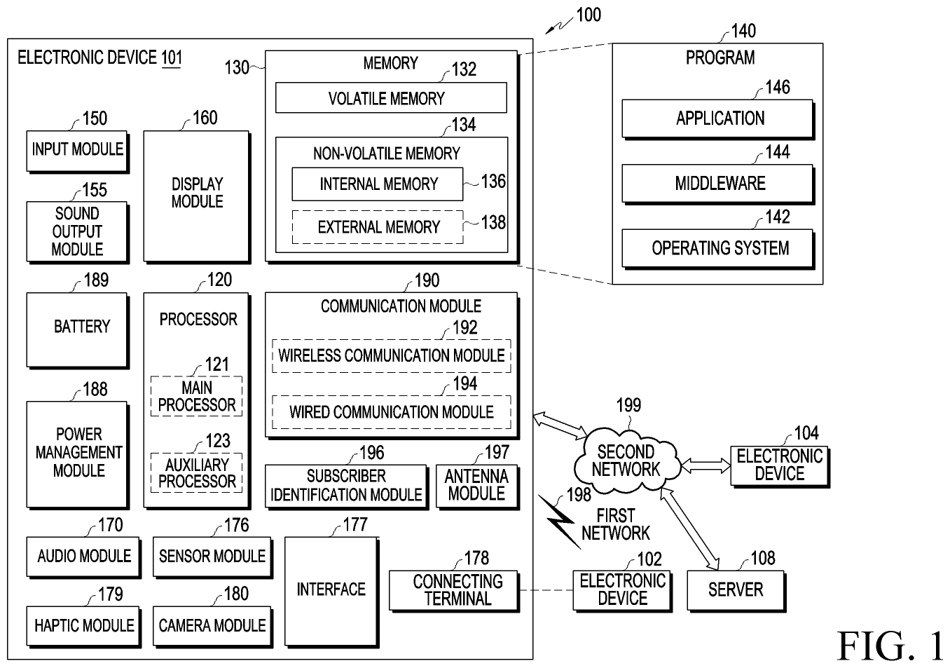

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a photo sensor, a light detection and ranging (lidar) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices (e.g., electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

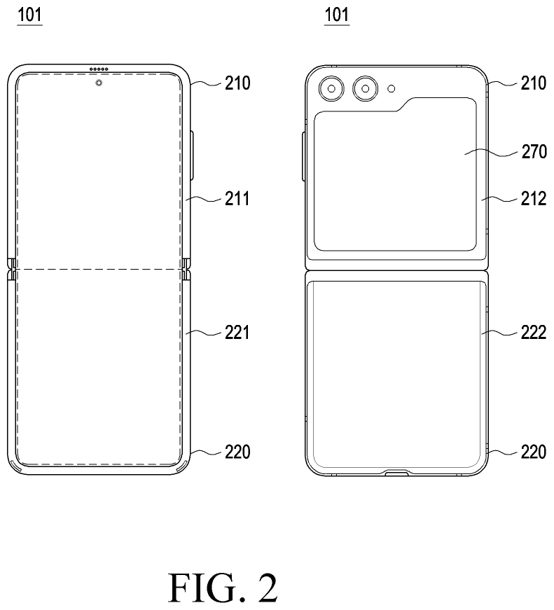

FIG. 2 is a view illustrating a front surface and a rear surface of an electronic device according to an embodiment of the disclosure.

Referring to FIG. 2, an electronic device 101 may include a pair of housings 210 and 220 (e.g., a foldable housing) that are rotatably coupled with respect to a folding axis through a hinge so as to be folded with respect to each other, and a foldable display 230 disposed in a space formed by the pair of housings 210 and 220.

According to embodiments, a first housing 210 and a second housing 220 may be disposed on two opposite sides of the folding axis (e.g., a folding axis in a horizontal direction). The hinge may be disposed between the first housing 210 and the second housing 220. The hinge may change the folding state of the first housing 210 and the second housing 220. As the first housing 210 and the second housing 220 rotate with respect to the folding axis through the hinge, the folding state of the electronic device 101 may be changed.

According to an embodiment, unlike the second housing 220, the first housing 210 includes an area in which a camera and various sensors are disposed, but may have a mutually symmetrical shape in other areas. In an embodiment, the area in which the camera and various sensors are disposed may be additionally disposed in, or replace, at least a partial area of the second housing 220.

In an embodiment, at least a portion of the camera or various sensors may be disposed in at least a partial area of the first housing 210, and the remaining portion may be disposed in at least a partial area of the second housing 220.

According to embodiments, the first housing 210 may include a first surface 211 disposed to face the front surface of the electronic device 101 in an unfolded state, a second surface 212 facing in the opposite direction of the first surface 211, and a first side member surrounding at least a portion of the space between the first surface 211 and the second surface 212.

According to embodiments, the second housing 220 may include a third surface 221 disposed to face the front surface of the electronic device 101 in an unfolded state, a fourth surface 222 facing in the opposite direction of the third surface 221, and a second side member surrounding at least a portion of the space between the third surface 221 and the fourth surface 222.

According to embodiments, at least a portion of the foldable display 230 may be visually exposed through the front surface (e.g., the first surface 211) of the first housing 210 and the front surface (e.g., the third surface 221) of the second housing 220. The foldable display 230 may be disposed on the first surface 211 of the first housing 210 and the third surface 221 of the second housing 220. The foldable display 230 may be disposed on the first surface 211 of the first housing 210, the hinge, and the third surface 221 of the second housing 220.

According to embodiments, the camera may be exposed on the front surface of the electronic device 101 through an opening provided in one corner of the first housing 210, or may be disposed at a lower end of at least a partial area of the foldable display 230. The sensors may include at least one of a proximity sensor, an illumination sensor, an iris recognition sensor, an ultrasonic sensor, or an indicator. For example, the sensors may be exposed on the front surface of the electronic device 101 through an opening provided in one corner of the first housing 210, or may be disposed at a lower end of at least a partial area of the foldable display 230.

According to an embodiment, the first housing 210 may include a receiver disposed through at least a partial area. In an embodiment, the electronic device 101 may include an ear jack hole, an external speaker module, an SIM card tray, an interface connector port, or at least one key button, which is not shown, disposed through the first housing 210 and/or the second housing 220.

According to embodiments, a state (e.g., an unfolded state, or a folded state) of the electronic device is set according to an angle between the first housing 210 and the second housing 220, and an operation of displaying an execution screen of an application may be performed according to the state of the electronic device (e.g., a state of the housings, a state of the hinge, or a curved state of the flexible display).

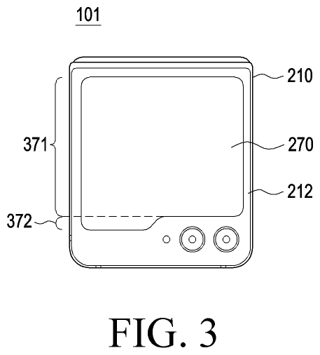

FIG. 3 is a view illustrating a folded state of an electronic device according to an embodiment of the disclosure.

According to embodiments, the electronic device 101 may include a pair of housings 210 and 220 (e.g., a foldable housing) that are rotatably coupled with respect to a folding axis (e.g., a folding axis in the horizontal direction) through a hinge to be folded with respect to each other, and a foldable display 230 disposed in a space formed by the pair of housings 210 and 220.

According to an embodiment, at least a portion of a cover display 270 may be visually exposed through the rear surface (e.g., the second surface 212) of the first housing 210. The cover display 270 may be disposed on the second surface 212 of the first housing 210.

According to embodiments, one or more components may be disposed or visually exposed on the rear surface of the electronic device 101. According to an embodiment, one or more components or sensors may be visually exposed through the rear surface (e.g., the second surface 212) of the first housing 210. The sensor may include a rear camera device 272 and/or a proximity sensor 274.

Referring to FIG. 3, a cover display 270 may include a main area 371 and a notch area 372. There is no limitation on the forms of the main area 371 and the notch area 372. An electronic device 101 (e.g., the processor 120) may control the cover display 270 to display a screen in the main area 371 and/or the notch area 372 of the cover display 270.

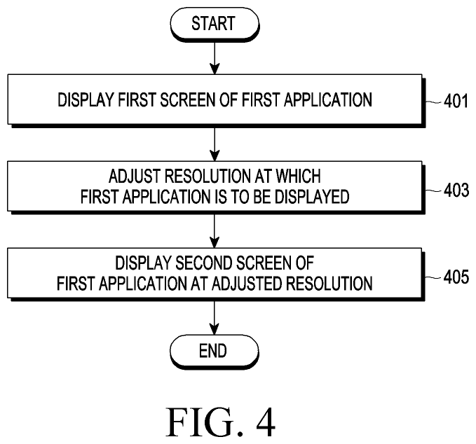

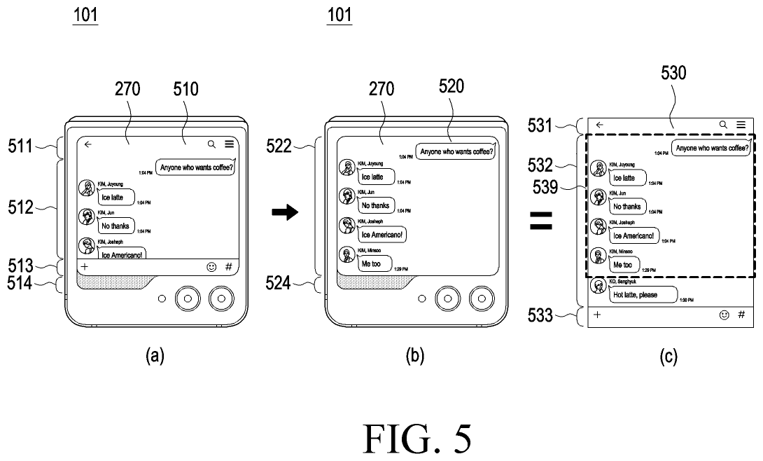

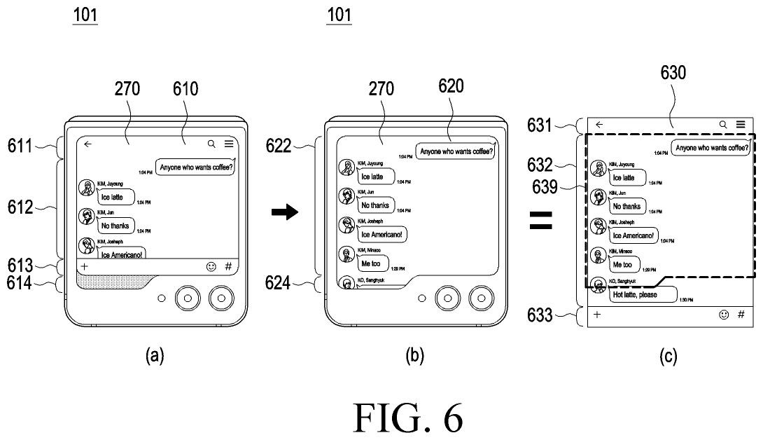

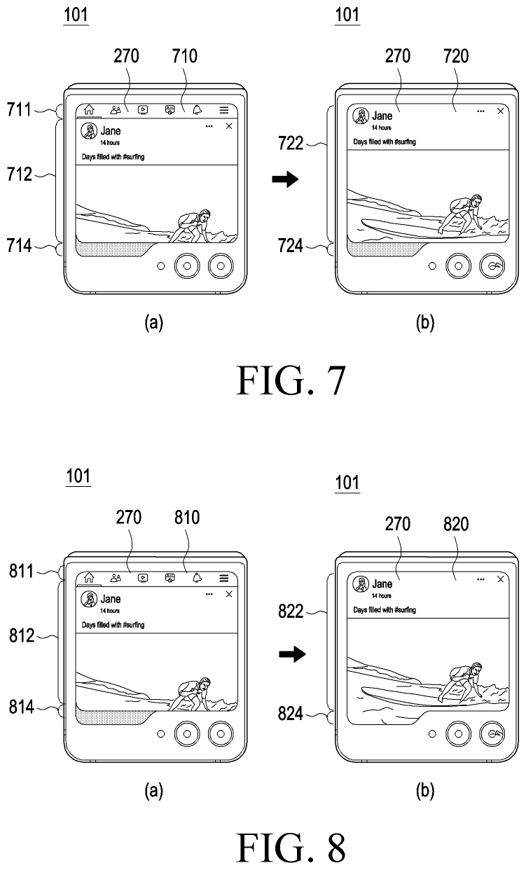

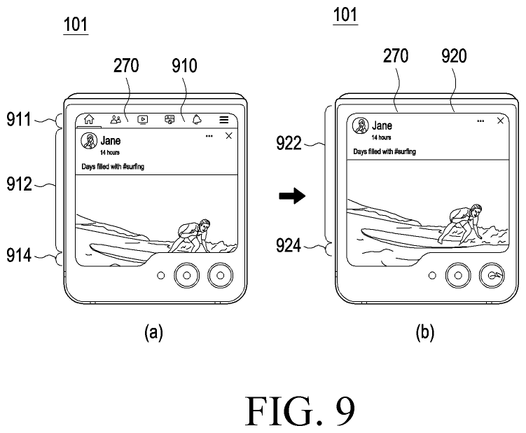

FIG. 4 is a flowchart illustrating an operation method of an electronic device according to an embodiment of the disclosure. FIG. 4 may be described with reference to FIGS. 5, 6, 7, 8, and 9. FIG. 5 is a view illustrating operations of an electronic device according to an embodiment of the disclosure. FIG. 6 is a view illustrating operations of an electronic device according to an embodiment of the disclosure. FIG. 7 is a view illustrating operations of an electronic device according to an embodiment of the disclosure. FIG. 8 is a view illustrating operations of an electronic device according to an embodiment of the disclosure. FIG. 9 is a view illustrating operations of an electronic device according to an embodiment of the disclosure.

At least some of the operations of FIG. 4 may be omitted. The operation order of the operations of FIG. 4 may be changed. Operations other than the operations of FIG. 4 may be performed before, during, or after performing the operations of FIG. 4.

Hereinafter, the display of the screen on the cover display 270 is described as an example, but this is for convenience of description, and there is no limitation on the display displaying the screen.

Referring to FIG. 4, according to an embodiment, in operation 401, an electronic device 101 (e.g., the processor 120) may display a first screen (e.g., first screen 510 of FIG. 5) of a first application on a cover display 270. The electronic device 101 may control the cover display 270 to display the first screen of the first application. There is no limit to the type of application. For example, the application (e.g., the first application) may be a messenger application. The first screen may be a screen having a first resolution (e.g., a first ratio). “Resolution” (e.g., the ratio) may be a size or a ratio (e.g., aspect ratio) of a screen (e.g., the first screen) of the application (e.g., the first application). “Ratio of the screen (e.g., resolution)” may be different from the ratio at which the screen is actually displayed on the display. For example, the ratio (e.g., resolution) of the screen (e.g., the first screen) may be the same as or different from the ratio (e.g., resolution) of the display (e.g., cover display 270). The size or ratio of the screen (e.g., the first screen) of the application (e.g., the first application) may be the same as or different from the size or ratio at which the screen (e.g., the first screen) is displayed on the display (e.g., the cover display 270). For example, when the ratio (e.g., the resolution) of the display (e.g., the cover display 270) is a first ratio (e.g., 1:1 (e.g., 1 horizontally to 1 vertically), if the ratio (e.g., resolution) of the screen (e.g., the first screen) to be displayed on the display (e.g., the cover display 270) is a first ratio, the entire screen (e.g., the first screen) may be displayed on the display (e.g., the cover display 270). For example, referring to part (a) of FIG. 5, when the ratio of the screen (e.g., the first screen 510) of the application (e.g., the first application) is the first ratio (e.g., 1:1) and the ratio of the display (e.g., the cover display 270) is the first ratio (e.g., 1:1), the entire screen (e.g., the first screen 510) may be displayed on the display (e.g., the cover display 270). For example, as described below in operation 405, when the ratio (e.g., resolution) of the display (e.g., the cover display 270) is the first ratio (e.g., 1:1), if the ratio (e.g., resolution) of the screen (e.g., the second screen) to be displayed on the display (e.g., the cover display 270) is a second ratio (e.g., 1:1.4), only a portion of the screen (e.g., the second screen) may be displayed on the display (e.g., the cover display 270), and another portion of the screen (e.g., the second screen) may not be displayed on the display (e.g., the cover display 270).

For example, in part (a) of FIG. 5, the first screen 510 of the first application may include an upper area 511, a content area 512, and a lower area 513. The upper area (e.g., the upper area 511) and/or the lower area (e.g., the lower area 513) may be a fixed area (e.g., a fixed UI) included in the screen (e.g., the first screen 510) of the application (e.g., the first application). The fixed area may be an area in which the position and size on the screen (e.g., the first screen 510) are fixed. The content area (e.g., the content area 512) may be an area in which the size of the area varies according to the ratio at the screen (e.g., the first screen 510) is displayed. For example, when the horizontal length of the cover display 270 and the horizontal length of the foldable display 230 are the same, the size of the upper area (e.g., the upper area 511) and/or the lower area (e.g., the lower area 513) when the screen (e.g., the first screen 510) is displayed on the cover display 270 having the first ratio (e.g., 1:2) may be the same as the size of the upper area and/or the lower area when the screen (e.g., the first screen 510) is displayed on the foldable display 230 having the second ratio (e.g., 1:2). For example, when the horizontal length of the cover display 270 and the horizontal length of the foldable display 230 are the same, the size of the content area (e.g., the content area 512) when the screen (e.g., the first screen 510) is displayed on the cover display 270 having the first ratio (e.g., the first screen 510) may be smaller than the size of the content area (e.g., the content area 512) when the screen (e.g., the first screen 510) is displayed on the foldable display 230 having the second ratio (e.g., 1:2). The size of the content area (e.g., the content area 512) may increase as the size of the displayed display increases. Referring to part (a) of FIG. 5, the first screen 510 may have the first ratio (e.g., 1:1), including the upper area 511, the content area 512, and the lower area 513. The first screen 510 having the first ratio (e.g., the first resolution) may be fully displayed on the cover display 270 having the first ratio (e.g., 1:1).

Referring to part (a) of FIG. 5, when displaying the first screen 510 of the first application, the electronic device 101 may not display a screen in a notch area 514 of the cover display 270. When displaying the first screen 510 of the first application, the electronic device 101 may display other information (e.g., time, battery information, etc.) irrelevant to the first application in the notch area 514 of the cover display 270.

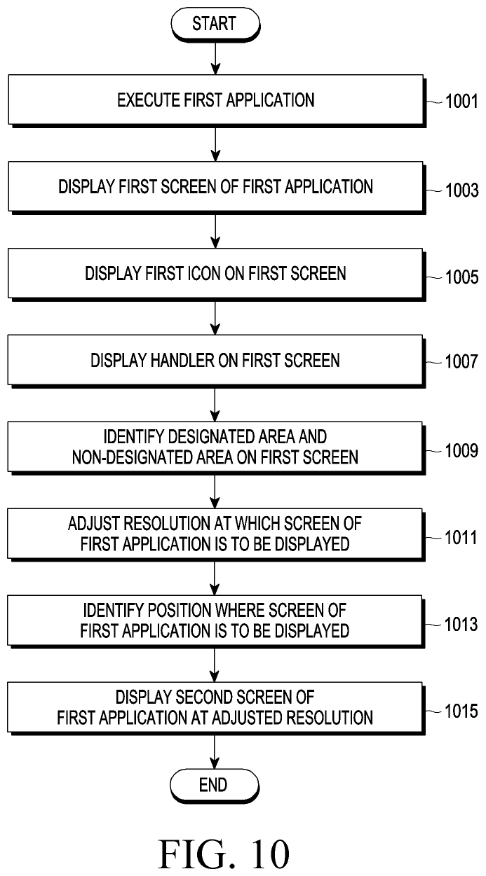

In operation 403, the electronic device 101 (e.g., the processor 120) may adjust the resolution (e.g., ratio) at which the first application (e.g., the screen of the first application) is to be displayed. The electronic device 101 may adjust the resolution (e.g., ratio) at which the first application (e.g., the screen of the first application) is to be displayed according to the embodiments described in FIGS. 10, 11, 12, 13, 14, 15, 16, 17, and 18. In operation 405, the electronic device 101 (e.g., the processor 120) may display the second screen of the first application (e.g., first application displayed on second screen 520 of FIG. 5) at the adjusted resolution. For example, referring to FIG. 5, the electronic device 101 may adjust the resolution (e.g., ratio) at which the first application (e.g., the screen of the first application) is to be displayed to the second resolution (e.g., the resolution of a third screen 530) in order to display a second screen 520 of the second resolution while displaying the first screen of the first resolution. In FIG. 5, a third screen 530 may be a diagram for describing a method of displaying the second screen 520. The third screen 530 may be the second screen 520. The third screen 530 may have a second resolution (e.g., a second ratio), including an upper area 531, a content area 532, and a lower area 533. When the electronic device 101 displays the third screen 530 having the second resolution on the cover display 270, the user may identify that the second screen 520 is displayed through the cover display 270. The display area of the second screen 520 displayed through the cover display 270 in FIG. 5 may be one area 539 of the third screen 530. For example, if the ratio (e.g., resolution) of the display (e.g., the cover display 270) is the first ratio (e.g., 1:1), and if the ratio (e.g., resolution) of the screen (e.g., second screen 520) to be displayed on the display (e.g., 1:1.4), only a portion of the screen (e.g., second screen 520) may be displayed on the display (e.g., the cover display 270), and the rest of the screen (e.g., second screen 520) may not be displayed on the display (e.g., the cover display 270). For example, referring to part (c) of FIG. 5, the upper area (e.g., upper area 531), and/or the lower area (e.g., lower area 533) of the screen (e.g., the cover display 270) may not be displayed on the display (e.g., the cover display 270). For example, referring to part (c) of FIG. 5, a portion of the content area (e.g., content area 532) of the screen (e.g., the third screen 530) may not be displayed on the display (e.g., the cover display 270). The area displayed on the display (e.g., the cover display 270) may be determined by a user input, which is described below.

Referring to part (b) of FIG. 5, when displaying a second screen 520 including a main area 522 of the first application, the electronic device 101 may not display a screen in a notch area 524 of the cover display 270. When displaying the second screen 520 of the first application, the electronic device 101 may display other information (e.g., time, battery information, etc.) irrelevant to the first application in the notch area 524 of the cover display 270. When displaying the second screen 520 of the first application, the electronic device 101 may display information (e.g., notification information) related to the first application in the notch area 524 of the cover display 270. When displaying the second screen 520 of the first application, the electronic device 101 may display some information of the upper area (e.g., upper area 511) and/or the lower area (e.g., 513) of the first application in the notch area 524 of the cover display 270.

FIG. 6 is a view illustrating an embodiment of displaying a content area in a notch area (e.g., notch area 624 of part (b) of FIG. 6) of a cover display.

Referring to FIG. 6, as shown in part (a) of FIG. 6, an electronic device 101 (e.g., the processor 120) may execute a first application and display a first screen 610 having a first resolution (e.g., a first ratio) on a cover display 270. The first screen 610 may have the first resolution (e.g., the first ratio), including an upper area 611, a content area 612, and a lower area 613. When displaying the first screen 610 of the first application, the electronic device 101 may not display a screen in a notch area 614 of the cover display 270. When displaying the first screen 610 of the first application, the electronic device 101 may display other information (e.g., time, battery information, etc.) irrelevant to the first application in the notch area 614 of the cover display 270. After displaying the first screen 610, the electronic device 101 may adjust the resolution at which the first application is to be displayed. For example, as shown in part (c) of FIG. 6, the resolution at which the first application is to be displayed may be adjusted to the second resolution (e.g., the second ratio) (e.g., the resolution of a third screen 630). Third screen 630 may have a second resolution (e.g., a second ratio), including an upper area 631, a content area 632, and a lower area 633. The electronic device 101 may display a second screen 620 (e.g., the third screen 630) of the first application at the adjusted resolution (e.g., the second resolution). When the electronic device 101 displays the third screen 630 having the second resolution on the cover display 270, the user may identify that the second screen 620 is displayed through the cover display 270. The display area of the second screen 620 displayed through the cover display 270 in FIG. 6 may be one area 639 of the third screen 630. One area 639 of the third screen 630 may include a notch area. Referring to part (b) FIG. 6, when displaying the second screen 620 including a main area 622 of the first application, the electronic device 101 may also display the second screen 620 in a notch area 624 of the cover display 270. The electronic device 101 may secure wide visibility of the user by displaying the second screen 620 in the notch area 624 of the cover display 270 as well.

FIGS. 7, 8, and 9 are views illustrating an embodiment in which a fixed area is only at an upper end of a screen of an application (e.g., a second application).

Referring to FIG. 7, as shown in part (a) of FIG. 7, an electronic device 101 (e.g., the processor 120) may execute a second application and display a first screen 710 having a first resolution (e.g., a first ratio) on a cover display 270. The first screen 710 may have the first resolution (e.g., the first ratio), including an upper area 711 and a content area 712. When displaying the first screen 710 of the second application, the electronic device 101 may not display a screen in a notch area 714 of the cover display 270. When displaying the first screen 710 of the second application, the electronic device 101 may display other information (e.g., time, battery information, etc.) irrelevant to the second application in the notch area 714 of the cover display 270. After displaying the first screen 710, the electronic device 101 may adjust the resolution at which the second application is to be displayed. For example, the resolution at which the second application is to be displayed may be adjusted to a second resolution (e.g., a second ratio). The electronic device 101 may display a second screen 720 of the second application at the adjusted resolution (e.g., the second resolution) on the cover display 270. The second screen 720 may have a second resolution (e.g., a second ratio) including an upper area, a main area 722, and a lower area, and only the main area 722 of the second screen 720 may be displayed on the cover display 270. Referring to part (b) of FIG. 7, when displaying the second screen 720 of the second application, the electronic device 101 may not display a screen in a notch area 724 of the cover display 270. When displaying the second screen 720 of the second application, the electronic device 101 may display other information (e.g., time, battery information, etc.) irrelevant to the second application in the notch area 724 of the cover display 270.

Referring to FIG. 8, as shown in part (a) of FIG. 8, an electronic device 101 (e.g., the processor 120) may execute a second application and display a first screen 810 having a first resolution (e.g., a first ratio) on a cover display 270. The first screen 810 may have the first resolution (e.g., the first ratio), including an upper area 811 and a content area 812. When displaying the first screen 810 of the second application, the electronic device 101 may not display a screen in a notch area 814 of the cover display 270. When displaying the first screen 810 of the second application, the electronic device 101 may display other information (e.g., time, battery information, etc.) irrelevant to the second application in the notch area 814 of the cover display 270. After displaying the first screen 810, the electronic device 101 may adjust the resolution at which the second application is to be displayed. For example, the resolution at which the second application is to be displayed may be adjusted to a second resolution (e.g., a second ratio). The electronic device 101 may display a second screen 820 of the second application at the adjusted resolution (e.g., the second resolution) on the cover display 270. The second screen 820 may have a second resolution (e.g., a second ratio) including an upper area, a content area, and a lower area, and only the content area of the second screen 820 may be displayed on the cover display 270. Referring to part (b) of FIG. 8, when displaying the second screen 820 of the second application, the electronic device 101 may display the second screen 820 in a main area 822 and a notch area 824 of the cover display 270. The electronic device 101 may secure wide visibility of the user by displaying the second screen 820 in the notch area 824 of the cover display 270 as well.

Referring to FIG. 9, as shown in part (a) of FIG. 9, an electronic device 101 (e.g., the processor 120) may execute a second application and display a first screen 910 having a first resolution (e.g., a first ratio) on a cover display 270. The first screen 910 may have the first resolution (e.g., the first ratio), including an upper area 911, a content area 912, and a notch area 914. When displaying the first screen 910 of the second application, the electronic device 101 may display a screen in the notch area 914 of the cover display 270 as well. After displaying the first screen 910, the electronic device 101 may adjust the resolution at which the second application is to be displayed. For example, the resolution at which the second application is to be displayed may be adjusted to a second resolution (e.g., a second ratio). The electronic device 101 may display a second screen 920 of the second application at the adjusted resolution (e.g., the second resolution) on the cover display 270. The second screen 920 may have a second resolution (e.g., a second ratio) including an upper area, a content area, and a lower area, and only the content area of the second screen 920 may be displayed on the cover display 270. Referring to part (b) of FIG. 9, when displaying the second screen 920 of the second application, the electronic device 101 may display the second screen 920 in a main area 922 a notch area 924 of the cover display 270. The electronic device 101 may secure wide visibility of the user by displaying the second screen 920 in the notch area 924 of the cover display 270 as well.

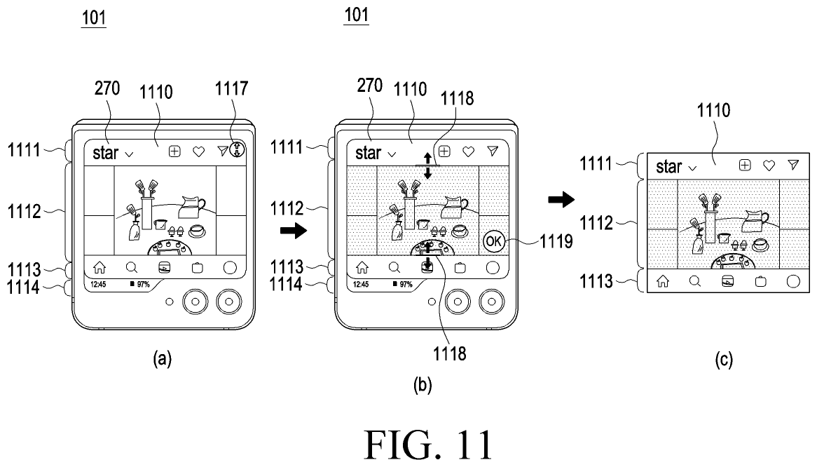

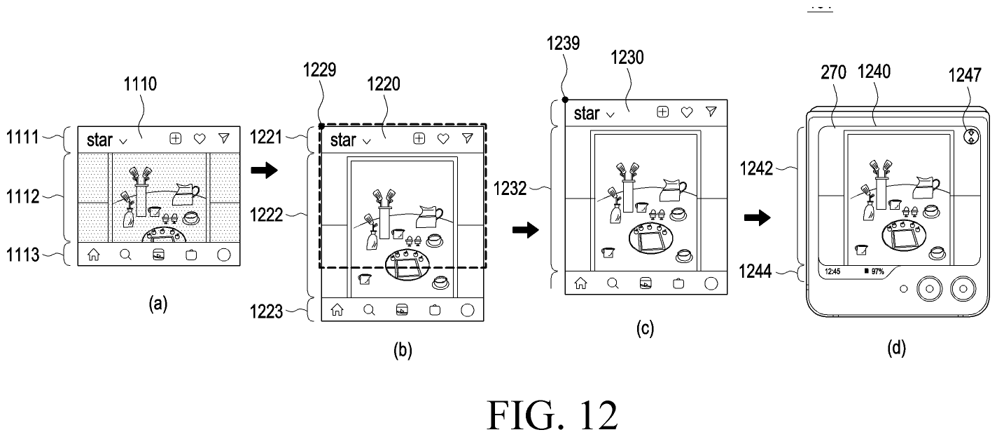

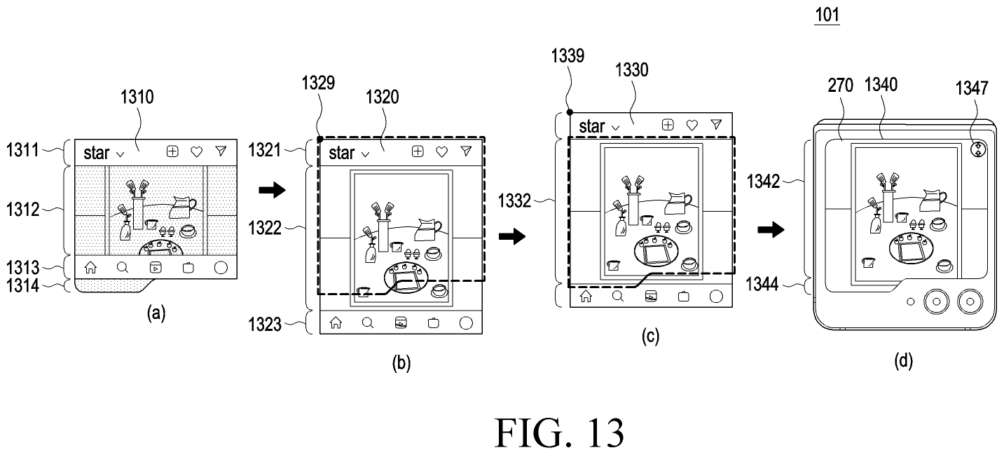

FIG. 10 is a flowchart illustrating an operation method of an electronic device according to an embodiment of the disclosure. FIG. 10 may be described with reference to FIGS. 11, 12, and 13. FIG. 11 is a view illustrating operations of an electronic device according to an embodiment of the disclosure. FIG. 12 is a view illustrating operations of an electronic device according to an embodiment of the disclosure. FIG. 13 is a view illustrating operations of an electronic device according to an embodiment of the disclosure.

At least some of the operations of FIG. 10 may be omitted. The operation order of the operations of FIG. 10 may be changed. Operations other than the operations of FIG. 10 may be performed before, while, or after performing the operations of FIG. 10. At least some of the operations of FIG. 10 may correspond to at least some of the operations of FIG. 4. The operations of FIG. 10 may be performed organically with the operations of FIG. 4.

Referring to FIG. 10, according to an embodiment, in operation 1001, an electronic device 101 (e.g., the processor 120) may execute the first application. There is no limit to the type of the first application.

In operation 1003, as shown in part (a) of FIG. 11, the electronic device 101 (e.g., the processor 120) may display a first screen (e.g., first screen 1110 of FIG. 11) of a first application on a cover display 270. The first screen may be a screen having a first resolution (e.g., a first ratio). Referring to FIG. 11, the first screen 1110 may have the first resolution (e.g., the first ratio), including an upper area 1111, a content area 1112, and a lower area 1113. When displaying the first screen 1110, the electronic device 101 may display other information (e.g., time, battery information, etc.) irrelevant to the first application in a notch area 1114. When displaying the first screen 1110, the electronic device 101 may also display the content area of the first screen 1110 in the notch area 1114. When displaying the first screen 1110, the electronic device 101 may not display the screen in the notch area 1114.

In operation 1005, the electronic device 101 (e.g., the processor 120) may display a first icon (e.g., first icon 1117 of FIG. 11) on the first screen (e.g., first screen 1110 of FIG. 11). Referring to FIG. 11, the electronic device 101 may display a first icon 1117 on the first screen 1110. The first icon 1117 may include a figure (e.g., up-and-down arrow) indicating an extension, but there is no limitation on the shape, size, and display position of the first icon 1117.

In operation 1007, the electronic device 101 (e.g., the processor 120) may display a handler (e.g., handler 1118 of FIG. 11) on the first screen (e.g., first screen 1110 of FIG. 11). A handler (e.g., handler 1118 of FIG. 11) may be a virtual object for selecting an area to be displayed on the display (e.g., the cover display 270). For example, referring to FIG. 11, the electronic device 101 may display the handler 1118 on the first screen 1110 based on a user input to the first icon 1117. For example, the handler 1118 may be moved on the first screen 1110 by a user input (e.g., drag and drop). As shown in FIG. 11, the handler 1118 may move up and down. According to an embodiment, the handler may be implemented to move left and right (or up, down, left and right). For example, referring to FIG. 11, the electronic device 101 may display an OK button 1119 on the first screen 1110. According to an embodiment, the virtual object for selecting an area to be displayed on the display (e.g., the cover display 270) may be implemented as a boundary line (e.g., the boundary line of the shaded area of part (b) of FIG. 11. In part (b) of FIG. 11, the handler 1118 is shown as being displayed at the boundary of the shaded area, but this is merely an example, and the handler 1118 may not be displayed. For example, the electronic device 101 may apply an effect (e.g., a shading effect) to the area (e.g., the inner area of the boundary line) divided by the boundary line (e.g., the boundary line of the shaded area of part (b) of FIG. 11) based on a user input to the first icon 1117 and move on the first screen 1110 and display the boundary line by a user input (e.g., up/down or left/right drag-and-drop) to the boundary line (e.g., the boundary line of the shaded area of part (b) of FIG. 11).

In operation 1009, the electronic device 101 (e.g., the processor 120) may identify a designated area (e.g., content area 1112 of FIG. 11) and a non-designated area (e.g., upper area 1111 and lower area 1113 of FIG. 11) on the first screen (e.g., the first screen 1110 of FIG. 11) based on the position where the handler (e.g., handler 1118 of FIG. 11) is displayed. The designated area (e.g., content area 1112 of FIG. 11) may be an area selected by the user. For example, the designated area (e.g., content area 1112 of FIG. 11) may be an area (e.g., a midway area of the handler (e.g., handler 1118 of FIG. 11)) selected by the handler (e.g., handler 1118 of FIG. 11). The non-designated area (e.g., upper area 1111 and lower area 1113 of FIG. 11) may be an area other than the designated area (e.g., content area 1112 of FIG. 11). For example, referring to FIG. 11, the electronic device 101 may identify the designated area (e.g., the content area 1112) and the non-designated area (e.g., the upper area 1111 and the lower area 1113) on the first screen 1110 according to the user's input to the OK button 1119, based on the position where the handler 1118 is displayed. For example, referring to part (c) of FIG. 11, the electronic device 101 may identify the size (e.g., height) of the designated area (e.g., the content area 1112 selected as the designated area). For example, the electronic device 101 may identify that the height of the content area 1112 selected as the designated area is x. The electronic device 101 may identify the size (e.g., height) of the non-designated area (e.g., the upper area 1111 which is a non-designated area). For example, the electronic device 101 may identify that the height of the upper area 1111, which is a non-designated area, is a. The electronic device 101 may identify the size (e.g., height) of the non-designated area (e.g., the lower area 1113 which is a non-designated area). For example, the electronic device 101 may identify that the height of the lower area 1113, which is a non-designated area, is b. In FIG. 11, the content area 1112 is selected as the designated area as the handler 1118 is positioned at the boundary of the upper area 1111, the content area 1112, and the lower area 1113, but this is merely an example, and depending on the position of the handler 1118, at least the portion of the upper area 1111 and/or at least the portion of the lower area 1113 may also be selected as the designated area. According to an embodiment, the handler 1118 is not displayed, and an area to be displayed on the display (e.g., the cover display 270) may be selected based on the position where the boundary line (e.g., the boundary line of the shaded area of part (b) of FIG. 11 is displayed. For example, the electronic device 101 may identify the designated area (e.g., content area 1112 of FIG. 11) and the non-designated area (e.g., upper area 1111 of FIG. 11) on the first screen 1110 based on the position where the boundary line (e.g., the boundary line of the shaded area of part (b) of FIG. 11) is displayed.

In operation 1011, the electronic device 101 (e.g., the processor 120) may adjust the resolution at which the screen of the first application is to be displayed. According to an embodiment, the electronic device 101 may adjust the resolution at which the screen of the first application is to be displayed without considering the notch area 372. According to an embodiment, the electronic device 101 may adjust the resolution at which the screen of the first application is to be displayed considering the notch area 372.

For example, referring to FIG. 12, an electronic device 101 may adjust the resolution at which the screen of the first application is to be displayed based on the size (e.g., height) of the designated area and the size (e.g., height) of the non-designated area identified in operation 1009. Part (a) of FIG. 12 is part (c) of FIG. 11. FIG. 12 may be the first screen 1110 having the first resolution. Part (b) of FIG. 12 may be a second screen 1220 having the second resolution. The electronic device 101 may adjust the resolution at which the screen of the first application is to be displayed, as shown in part (b) of FIG. 12. After displaying the first screen 1110 of the first resolution on the cover display 270, the electronic device 101 may adjust the resolution at which the screen of the first application is to be displayed to the second resolution (e.g., the resolution of the second screen 1220). Referring to part (b) of FIG. 12, the second screen 1220 may have the second resolution (e.g., the second ratio) including an upper area 1221, a content area 1222, and a lower area 1223. The size (e.g., height) of the content area 1222 of the second screen 1220 may be the sum of the size (e.g., height) of the designated area (e.g., the content area 1112) of the first screen 1110 and the size (e.g., height) of the non-designated area (e.g., upper area 1111 and lower area 1113) of the first screen 1110. When the size (e.g., height) of the designated area (e.g., the content area 1112) on the first screen 1110 is x and the size (e.g., height) of the non-designated area (e.g., upper area 1111 and lower area 1113) is a+b, the size (e.g., height) x′ of the content area 1222 of the second screen 1220 may be x+a+b.

Referring to FIG. 13, an electronic device 101 may adjust the resolution at which the screen of the first application is to be displayed based on the size (e.g., height) of the designated area, the size (e.g., height) of the non-designated area, and the size (e.g., height) of the notch area, which are identified in operation 1009. Part (a) of FIG. 13 may be part (c) of FIG. 11. Part (a) of FIG. 13 may be a first screen 1310 having the first resolution. Part (b) of FIG. 13 may be a second screen 1320 having the second resolution. The electronic device 101 may adjust the resolution at which the screen of the first application is to be displayed, as shown in part (b) of FIG. 13. After displaying the first screen 1310 of the first resolution on the cover display 270, the electronic device 101 may adjust the resolution at which the screen of the first application is to be displayed to the second resolution (e.g., the resolution of the second screen 1320). Referring to part (b) of FIG. 13, the second screen 1320 may have the second resolution (e.g., the second ratio) including an upper area 1321, a content area 1322, and a lower area 1323. The size (e.g., height) of the content area 1322 of the second screen 1320 may be the sum of the size (e.g., height) of the designated area (e.g., content area 1312) of the first screen 1310, the size (e.g., height) of the non-designated area (e.g., upper area 1311 and lower area 1313) of the first screen 1310, and the size (e.g., height) of a notch area 1314. When the size (e.g., height) of the designated area (e.g., content area 1312) on the first screen 1310 is x, the size (e.g., height) of the non-designated area (e.g., upper area 1311 and lower area 1313) is a+b, and the size (e.g., height) of the content area 1322 of the second screen 1320 is n, the size (e.g., height) x′ may be x+a+b+n.

In operation 1013, the electronic device 101 (e.g., the processor 120) may identify the position where the screen of the first application is to be displayed. The electronic device 101 may identify the position where the screen of the first application is to be displayed based on the size (e.g., height) of the designated area and the size (e.g., height) of the non-designated area identified in operation 1009.

For example, referring to parts (b) and (c) of FIG. 12, the electronic device 101 may move the position where the screen of the first application is to be displayed by the size (e.g., height) of the non-designated area (e.g., the upper area 1221 of the non-designated area). For example, the electronic device 101 may move the position where the screen of the first application is to be displayed from a first point 1229 of part (b) of FIG. 12 to a second point 1239 of part (c) of FIG. 12 by the size (e.g., height) of the non-designated area (e.g., the upper area 1221 of the non-designated area).

For example, referring to parts (b) and (c) of FIG. 13, the electronic device 101 may move the position where the screen of the first application is to be displayed by the size (e.g., height) of the non-designated area (e.g., the upper area 1321 of the non-designated area). For example, the electronic device 101 may move the position where the screen of the first application is to be displayed from a first point 1329 of part (b) of FIG. 13 to a second point 1339 of part (c) of FIG. 13 by the size (e.g., height) of the non-designated area (e.g., the upper area 1321 of the non-designated area).

In operation 1015, the electronic device 101 (e.g., the processor 120) may display a screen (e.g., screen 1240 of FIG. 12 or screen 1340 of FIG. 13) of the first application on the cover display 270 at the adjusted resolution (e.g., the second resolution).

For example, referring to FIG. 12, the electronic device 101 may display the designated area (e.g., content area 1232 of a third screen 1230) of the first application in a main area 1242 of the cover display 270, as shown in screen 1240. The electronic device 101 may display other information (e.g., time, battery information, etc.) irrelevant to the first application in a notch area 1244 of the cover display 270.

For example, referring to FIG. 13, the electronic device 101 may display the designated area (e.g., content area 1332 of third screen 1330) of the first application in a main area 1342 and a notch area 1344 of the cover display 270, as shown in screen 1340.

Referring to FIGS. 12 and 13, as shown in part (d) of FIG. 12 or part (d) of FIG. 13, an electronic device 101 may display an icon (e.g., icon 1247 of FIG. 12 or icon 1347 of FIG. 13) for displaying the first screen (e.g., first screen 1110 of FIG. 11) on the second screen (e.g., screen 1240 of FIG. 12 or screen 1340 of FIG. 13). According to a user input to the icon (e.g., icon 1247 of FIG. 12 or icon 1347 of FIG. 13), the electronic device 101 may display the first screen (e.g., first screen 1110 of FIG. 11) on the cover display 270.

According to an embodiment, the electronic device 101 may store setting data related to the first application. The “setting data” may include information about the resolution of the screen of the application and the display position of the screen. For example, the electronic device 101 may store information about the adjusted resolution and/or information about the position where the screen is to be displayed in relation to the first application.

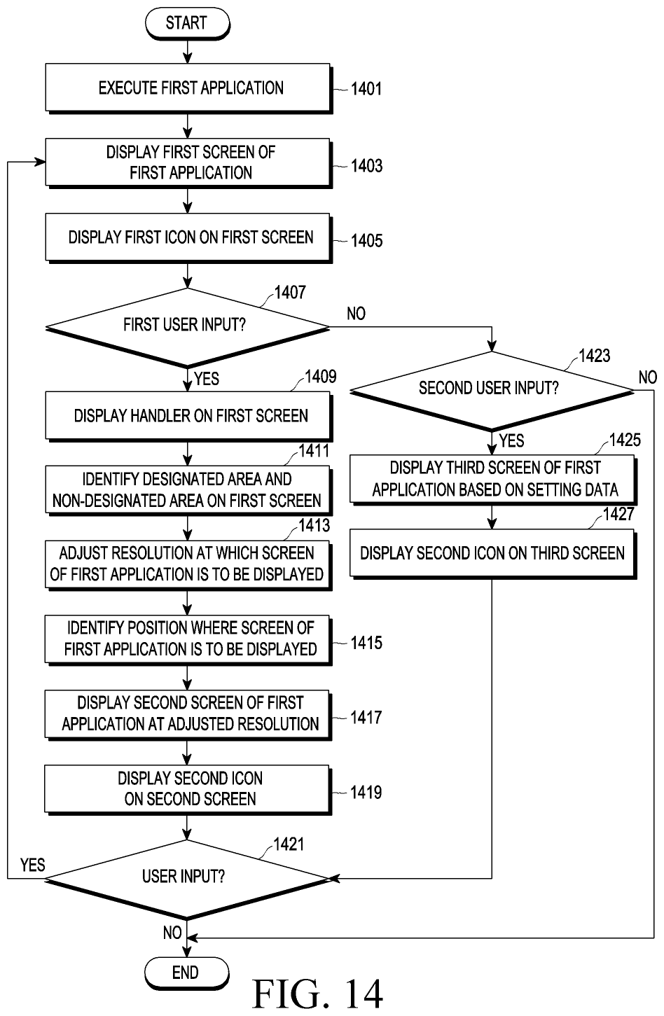

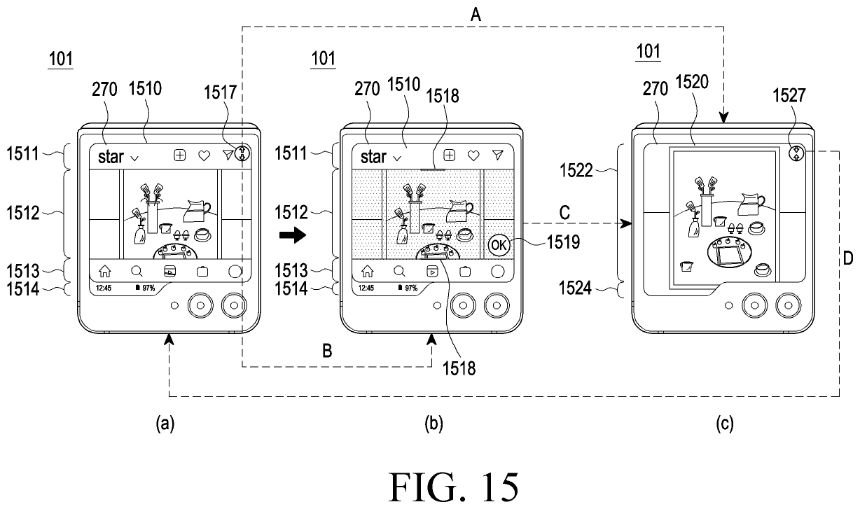

FIG. 14 is a flowchart illustrating an operation method of an electronic device according to an embodiment of the disclosure. FIG. 14 may be described with reference to FIG. 15. FIG. 15 is a view illustrating operations of an electronic device according to an embodiment of the disclosure.

At least some of the operations of FIG. 14 may be omitted. The operation order of the operations of FIG. 14 may be changed. Operations other than the operations of FIG. 14 may be performed before, while, or after performing the operations of FIG. 14. At least some of the operations of FIG. 14 may correspond to at least some of the operations of FIGS. 4 and 10. The operations of FIG. 14 may be organically performed with the operations of FIGS. 4 and 10.

Referring to FIG. 14, according to an embodiment, in operation 1401, an electronic device 101 (e.g., the processor 120) may execute the first application. Operation 1401 may be operation 1001 of FIG. 10.

In operation 1403, the electronic device 101 (e.g., the processor 120) may display a first screen (e.g., first screen 1510 of FIG. 15) of a first application on the cover display 270. The first screen may be a screen having a first resolution (e.g., a first ratio). Operation 1403 may be operation 1003 of FIG. 10. The first screen may have the first resolution (e.g., the first ratio), including an upper area 1511, a content area 1512, and a lower area 1513. When displaying the first screen (e.g., first screen 1510 of FIG. 15), the electronic device 101 may display other information (e.g., time, battery information, etc.) irrelevant to the first application in a notch area 1514 of the cover display 270. When displaying the first screen (e.g., first screen 1510 of FIG. 15), the electronic device 101 may not display a screen in the notch area 1514 of the cover display 270.

In operation 1405, as shown in part (a) of FIG. 15, the electronic device 101 (e.g., the processor 120) may display a first icon (e.g., first icon 1517 of FIG. 15) on the first screen (e.g., first screen 1510 of FIG. 15). Operation 1405 may be operation 1005 of FIG. 10.

In operation 1407, the electronic device 101 (e.g., the processor 120) may perform operation 1409 according to a first user input to the first icon (e.g., first icon 1517 of FIG. 15).

In operation 1409, as shown in part (b) of FIG. 15, the electronic device 101 (e.g., the processor 120) may display a handler (e.g., handler 1518 of FIG. 15) on the first screen (e.g., first screen 1510 of FIG. 15) according to the first user input (e.g., first user input B of FIG. 15) to the first icon (e.g., first icon 1517 of FIG. 15). For example, the first user input (e.g., first user input B of FIG. 15) may be a touch input to the first icon (e.g., first icon 1517 of FIG. 15), but there is no limitation on the type of the first user input (e.g., first user input B of FIG. 15). The electronic device 101 may adjust the display position of the handler (e.g., handler 1518 of FIG. 15) based on a user input to the handler (e.g., handler 1518 of FIG. 15). Operation 1409 may be operation 1007 of FIG. 10.

In operation 1411, the electronic device 101 (e.g., the processor 120) may identify a designated area (e.g., content area 1512 of FIG. 15) and a non-designated area (e.g., upper area 1511 and lower area 1513 of FIG. 15) on the first screen (e.g., the first screen 1510 of FIG. 15) based on the position where the handler (e.g., handler 1518 of FIG. 15) is displayed. For example, referring to part (b) FIG. 15, the electronic device 101 may identify the designated area (e.g., the content area 1512) and the non-designated area (e.g., the upper area 1511 and the lower area 1513) on the first screen 1510 according to the user's input (e.g., user input C of FIG. 15) to an OK button 1519, based on the position where the handler 1518 is displayed. Operation 1411 may be operation 1009 of FIG. 10.

In operation 1413, the electronic device 101 (e.g., the processor 120) may adjust the resolution at which the screen of the first application is to be displayed. Operation 1413 may be operation 1011 of FIG. 10.

In operation 1415, the electronic device 101 (e.g., the processor 120) may identify the position where the screen of the first application is to be displayed. Operation 1415 may be operation 1013 of FIG. 10.

In operation 1417, the electronic device 101 (e.g., the processor 120) may display the second screen (e.g., second screen 1520 of FIG. 15) of the first application on the cover display 270 at the adjusted resolution (e.g., the second resolution). Referring to FIG. 15, the electronic device 101 may display the designated area (e.g., the content area) of a second screen 1520 in a main area 1522 and a notch area 1524 of the cover display 270. Operation 1417 may be operation 1015 of FIG. 10.

In operation 1419, the electronic device 101 (e.g., the processor 120) may display a second icon (e.g., second icon 1527 of FIG. 15) for displaying the first screen (e.g., first screen 1510 of FIG. 15) on the second screen (e.g., second screen 1520 of FIG. 15).

In operation 1421, the electronic device 101 (e.g., the processor 120) may display the first screen (e.g., first screen 1510 of FIG. 15) of the first application on the cover display 270 according to a user input (e.g., user input D of FIG. 15) to the second icon (e.g., second icon 1527 of FIG. 15).

In operation 1423, the electronic device 101 (e.g., the processor 120) may perform operation 1425 according to a second user input to the first icon (e.g., first icon 1517 of FIG. 15).

In operation 1425, the electronic device 101 (e.g., the processor 120) may display a third screen (e.g., second screen 1520 of FIG. 15) of the first application on the cover display 270 based on the setting data of the first application according to the second user input (e.g., second user input A of FIG. 15) to the first icon (e.g., first icon 1517 of FIG. 15). For example, the second user input (e.g., second user input A of FIG. 15) may be a long press input to the first icon (e.g., first icon 1517 of FIG. 15), but there is no limit to the type of the second user input (e.g., second user input A of FIG. 15). The electronic device 101 may omit operations 1409, 1411, 1413, and 1415 according to the second user input (e.g., second user input A of FIG. 15) to the first icon (e.g., first icon 1517 of FIG. 15), and may immediately display the designated screen (e.g., second screen 1520 of FIG. 15) according to the setting data. Although the second screen 1520 of part (c) of FIG. 15 is used as an example of the second screen in operation 1417, and the second screen 1520 of part (c) of FIG. 15 is used as an example of the third screen in operation 1425, it will be appreciated by one of ordinary skill in the art that the second screen of operation 1417 and the third screen of operation 1425 may be different screens.

In operation 1427, the electronic device 101 (e.g., the processor 120) may display a second icon (e.g., second icon 1527 of FIG. 15) for displaying the first screen (e.g., first screen 1510 of FIG. 15) on the third screen (e.g., second screen 1520 of FIG. 15) based on the setting data. The electronic device 101 may perform operation 1421 in relation to the second icon (e.g., second icon 1527 of FIG. 15) displayed on the third screen (e.g., second screen 1520 of FIG. 15) after operation 1427.

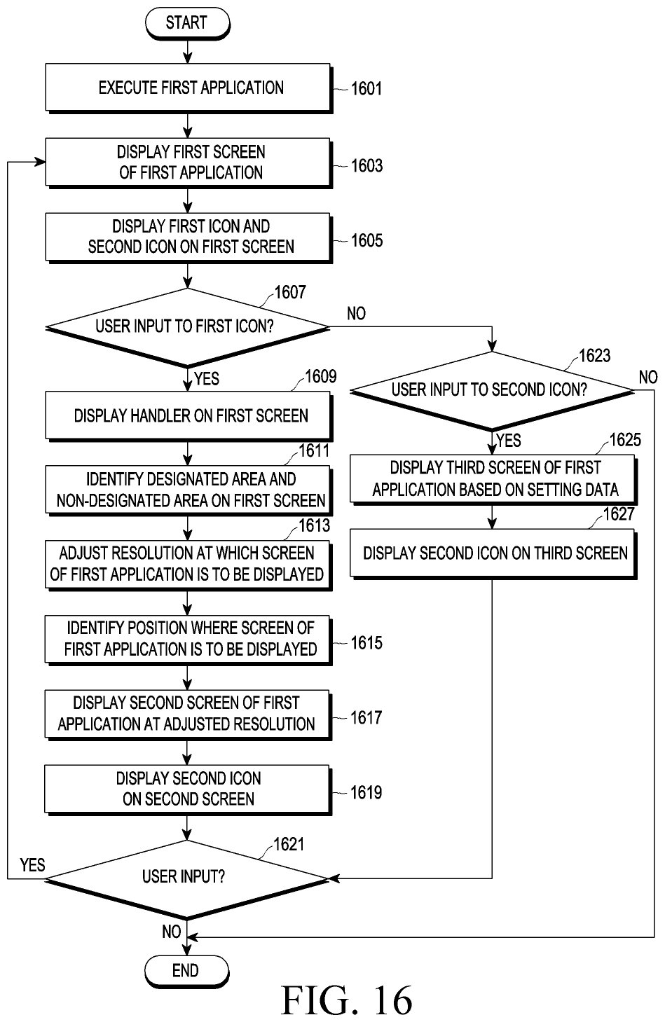

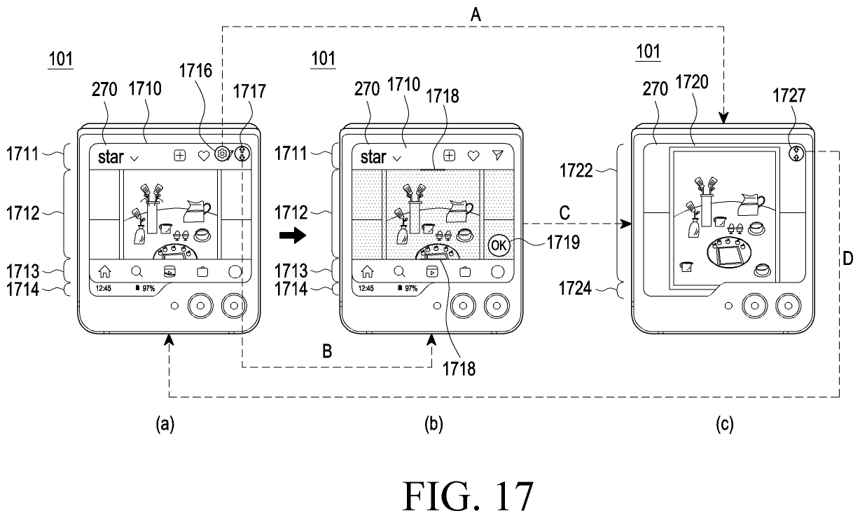

FIG. 16 is a flowchart illustrating an operation method of an electronic device according to an embodiment of the disclosure. FIG. 16 may be described with reference to FIG. 17. FIG. 17 is a view illustrating operations of an electronic device according to an embodiment of the disclosure.

At least some of the operations of FIG. 16 may be omitted. The operation order of the operations of FIG. 16 may be changed. Operations other than the operations of FIG. 16 may be performed before, while, or after performing the operations of FIG. 16. At least some of the operations of FIG. 16 may correspond to at least some of the operations of FIGS. 4 and 10. The operations of FIG. 16 may be organically performed with the operations of FIGS. 4 and 10.

Referring to FIG. 16, according to an embodiment, in operation 1601, the electronic device 101 (e.g., the processor 120) may execute the first application. Operation 1601 may be operation 1001 of FIG. 10.

In operation 1603, the electronic device 101 (e.g., the processor 120) may display a first screen (e.g., first screen 1710 of part (a) of FIG. 17) of a first application on the cover display 270. The first screen may be a screen having a first resolution (e.g., a first ratio). Operation 1603 may be operation 1003 of FIG. 10. The first screen may have the first resolution (e.g., the first ratio), including an upper area 1711, a content area 1712, and a lower area 1713. When displaying the first screen (e.g., first screen 1710 of FIG. 17), the electronic device 101 may display other information (e.g., time, battery information, etc.) irrelevant to the first application in a notch area 1714 of the cover display 270. When displaying the first screen (e.g., first screen 1710 of FIG. 17), the electronic device 101 may not display a screen in the notch area 1714 of the cover display 270.

In operation 1605, the electronic device 101 (e.g., the processor 120) may display a first icon (e.g., first icon 1717 of FIG. 15) and a second icon (e.g., second icon 1716 of FIG. 17) on the first screen (e.g., first screen 1710 of FIG. 17). There is no limitation on the shape, size, and display position of the first icon (e.g., first icon 1717 of FIG. 15) and the second icon (e.g., second icon 1716 of FIG. 17).

In operation 1607, the electronic device 101 (e.g., the processor 120) may perform operation 1609 according to a user input to the first icon (e.g., first icon 1717 of FIG. 17).

In operation 1609, the electronic device 101 (e.g., the processor 120) may display a handler (e.g., handler 1718 of part (b) of FIG. 17) on the first screen (e.g., first screen 1710 of FIG. 17) according to the user input (e.g., user input B of FIG. 17) to the first icon (e.g., first icon 1717 of FIG. 17). For example, the user input (e.g., user input B of FIG. 17) may be a touch input to the first icon (e.g., first icon 1717 of FIG. 17), but there is no limitation on the type of the first user input (e.g., user input B of FIG. 17). The electronic device 101 may adjust the display position of the handler (e.g., handler 1718 of FIG. 17) based on a user input to the handler (e.g., handler 1718 of FIG. 17).

In operation 1611, the electronic device 101 (e.g., the processor 120) may identify a designated area (e.g., content area 1712 of FIG. 17) and a non-designated area (e.g., upper area 1711 and lower area 1713 of FIG. 17) on the first screen (e.g., the first screen 1710 of FIG. 17) based on the position where the handler (e.g., handler 1718 of FIG. 17) is displayed. For example, referring to FIG. 17, the electronic device 101 may identify the designated area (e.g., the content area 1712) and the non-designated area (e.g., the upper area 1711 and the lower area 1713) on the first screen 1710 according to the user's input (e.g., user input C of FIG. 17) to an OK button 1719, based on the position where the handler 1718 is displayed.

In operation 1613, the electronic device 101 (e.g., the processor 120) may adjust the resolution at which the screen of the first application is to be displayed. Operation 1613 may be operation 1011 of FIG. 10.

In operation 1615, the electronic device 101 (e.g., the processor 120) may identify the position where the screen of the first application is to be displayed. Operation 1615 may be operation 1013 of FIG. 10.

In operation 1617, the electronic device 101 (e.g., the processor 120) may display the second screen (e.g., second screen 1720 of part (c) of FIG. 17) of the first application on the cover display 270 at the adjusted resolution (e.g., the second resolution). Referring to FIG. 17, the electronic device 101 may display the designated area (e.g., the content area) of the second screen 1720 in a main area 1722 and a notch area 1724 of the cover display 270. Operation 1417 may be operation 1015 of FIG. 10.

In operation 1619, the electronic device 101 (e.g., the processor 120) may display a third icon (e.g., third icon 1727 of FIG. 17) for displaying the first screen (e.g., first screen 1710 of FIG. 17) on the second screen (e.g., second screen 1720 of FIG. 17).

In operation 1621, the electronic device 101 (e.g., the processor 120) may display the first screen (e.g., first screen 1710 of FIG. 17) of the first application on the cover display 270 according to a user input (e.g., user input D of FIG. 17) to the third icon (e.g., third icon 1727 of FIG. 17).

In operation 1623, the electronic device 101 (e.g., the processor 120) may perform operation 1625 according to a user input to the second icon (e.g., second icon 1716 of FIG. 17).

In operation 1625, the electronic device 101 (e.g., the processor 120) may display a third screen (e.g., second screen 1720 of FIG. 17) of the first application on the cover display 270 based on the setting data of the first application according to a second user input (e.g., second user input A of FIG. 17) to the second icon (e.g., second icon 1716 of FIG. 17). For example, the second user input (e.g., second user input A of FIG. 17) may be a touch input to the second icon (e.g., second icon 1716 of FIG. 17), but there is no limit to the type of the second user input (e.g., second user input A of FIG. 17). Operation 1625 may be understood as similar to operation 1425 of FIG. 14.

In operation 1627, the electronic device 101 (e.g., the processor 120) may display the third icon (e.g., third icon 1727 of FIG. 17) for displaying the first screen (e.g., first screen 1710 of FIG. 17) on the third screen (e.g., second screen 1720 of FIG. 17) based on the setting data. The electronic device 101 may perform operation 1621 in relation to the third icon (e.g., third icon 1727 of FIG. 17) displayed on the third screen (e.g., second screen 1720 of FIG. 17) after operation 1627.

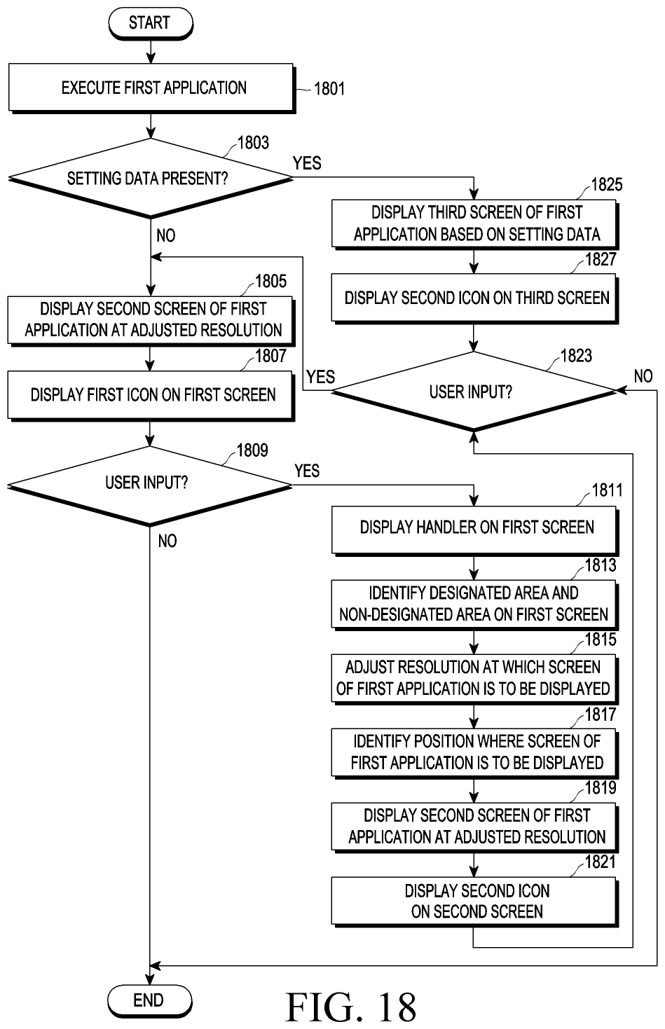

FIG. 18 is a flowchart illustrating an operation method of an electronic device according to an embodiment of the disclosure.

At least some of the operations of FIG. 18 may be omitted. The operation order of the operations of FIG. 18 may be changed. Operations other than the operations of FIG. 18 may be performed before, while, or after performing the operations of FIG. 18. At least some of the operations of FIG. 18 may correspond to at least some of the operations of FIGS. 4, 10, 14, and 16. The operations of FIG. 18 may be organically performed with the operations of FIGS. 4, 10, 14, and 16.

Referring to FIG. 18, according to an embodiment, in operation 1801, an electronic device 101 (e.g., the processor 120) may execute the first application. Operation 1401 may be operation 1001 of FIG. 10.

In operation 1803, the electronic device 101 (e.g., the processor 120) may identify whether there is setting data related to the first application. The setting data may include information about the resolution of the screen of the application and the display position of the screen.

In operation 1805, the electronic device 101 (e.g., the processor 120) may display the first screen of the first application on the cover display 270 based on the absence of the setting data related to the first application.

In operation 1807, the electronic device 101 (e.g., the processor 120) may display a first icon on the first screen. Operation 1807 may be operation 1005 of FIG. 10.

In operation 1809, the electronic device 101 (e.g., the processor 120) may perform operation 1811 based on a user input to the first icon.

In operation 1811, the electronic device 101 (e.g., the processor 120) may display a handler on the first screen based on a user input to the first icon. The electronic device 101 may adjust the position where the handler is displayed based on a user input to the handler. Operation 1811 may be operation 1007 of FIG. 10.

In operation 1813, the electronic device 101 (e.g., the processor 120) may identify the designated area and the non-designated area on the first screen based on the position where the handler is displayed. Operation 1813 may be operation 1009 of FIG. 10.

In operation 1815, the electronic device 101 (e.g., the processor 120) may adjust the resolution at which the screen of the first application is to be displayed. Operation 1815 may be operation 1011 of FIG. 10.

In operation 1817, the electronic device 101 (e.g., the processor 120) may identify the position where the screen of the first application is to be displayed. Operation 1817 may be operation 1013 of FIG. 10.

In operation 1819, the electronic device 101 (e.g., the processor 120) may display the second screen of the first application on the cover display 270 at the adjusted resolution (e.g., the second resolution). Operation 1819 may be operation 1015 of FIG. 10.

In operation 1821, the electronic device 101 (e.g., the processor 120) may display a second icon for displaying the first screen on the second screen.

In operation 1823, the electronic device 101 (e.g., the processor 120) may display the first screen of the first application on the cover display 270 according to a user input to the second icon.

In operation 1825, the electronic device 101 (e.g., the processor 120) may display the third screen of the first application on the cover display 270 based on the absence of the setting data related to the first application. The third screen may be a screen determined according to the setting data.

In operation 1827, the electronic device 101 (e.g., the processor 120) may display a second icon for displaying the first screen on the third screen displayed based on the setting data. The electronic device 101 may perform operation 1823 in relation to the second icon displayed on the third screen after operation 1827.

Those skilled in the art may understand that the embodiments described in the disclosure may be applied organically to each other within an applicable range. For example, those skilled in the art may understand that at least some operations of an embodiment described herein may be omitted, or that at least some operations of an embodiment and at least some operations of another embodiment may be organically connected.

According to an embodiment, an electronic device 101 may comprise a cover display 270 and a processor 120. The processor 120 may be configured to display a first screen of a first application on the cover display 270. The processor 120 may be configured to identify a designated area and a non-designated area on the first screen based on a user input on the first screen. The processor 120 may be configured to adjust a resolution where a screen of the first application is to be displayed based on a size of the designated area and a size of the non-designated area. The processor 120 may be configured to display a second screen of the first application on the cover display 270 at the adjusted resolution.

According to an embodiment, the processor 120 may be configured to identify a position where the screen of the first application is to be displayed based on the size of the designated area and the size of the non-designated area. The processor 120 may be configured to display the second screen at the identified position at the adjusted resolution.

According to an embodiment, the processor 120 may be configured to display a first icon on the first screen. The processor 120 may be configured to display a handler on the first screen based on a first user input to the first icon. The processor 120 may be configured to identify the designated area and the non-designated area on the first screen based on a second user input to the handler.

According to an embodiment, the processor 120 may be configured to identify whether there is setting data related to the first application based on a third user input to the first icon. The processor 120 may be configured to display a third screen according to the setting data on the cover display 270 based on a presence of the setting data.

According to an embodiment, the processor 120 may be configured to identify whether there is the setting data related to the first application based on the third user input to the first icon. The processor 120 may be configured to display the handler on the first screen based on an absence of the setting data.

According to an embodiment, the processor 120 may be configured to display a first icon and a second icon on the first screen. The processor 120 may be configured to, based on a first user input to the first icon, display a handler on the first screen, and identify the designated area and the non-designated area on the first screen based on a second user input to the handler. The processor 120 may be configured to, based on a fourth user input to the second icon, identify whether there is setting data related to the first application and display a third screen according to the setting data on the cover display 270 based on a presence of the setting data.

According to an embodiment, the processor 120 may be configured to display a third icon for displaying the first screen on the second screen. The processor 120 may be configured to display the first screen on the cover display 270 based on a user input to the third icon.

According to an embodiment, the first display may include a notch area. The processor 120 may be configured to adjust the resolution based on the size of the designated area, the size of the non-designated area, and the size of the notch area.

According to an embodiment, the processor 120 may be configured to store setting data related to the adjusted resolution.

According to an embodiment, the electronic device 101 may comprise a foldable display 230. The cover display 270 may be disposed on a second surface 212 of a first housing 210 of the electronic device 101. The foldable display 230 may be disposed on a first surface 211 of the first housing 210 of the electronic device 101 and a third surface 221 of a second housing 220 of the electronic device 101. The second surface 212 may face in a direction opposite to the first surface 211. The second housing 220 may include the third surface 221 and a fourth surface 222 facing in a direction opposite to the third surface 221. The first surface 211 and the third surface 221 may contact each other in state in which the first housing 210 and the second housing 220 are folded.

According to an embodiment, a method for operating an electronic device 101 may comprise displaying a first screen of a first application on a cover display 270 of the electronic device 101. The method may comprise identifying a designated area and a non-designated area on the first screen based on a user input on the first screen. The method may comprise adjusting a resolution where a screen of the first application is to be displayed based on a size of the designated area and a size of the non-designated area. The method may comprise displaying a second screen of the first application on the cover display 270 at the adjusted resolution.

According to an embodiment, the method may comprise identifying a position where the screen of the first application is to be displayed based on the size of the designated area and the size of the non-designated area. Displaying the second screen on the cover display 270 may include displaying the second screen at the identified position at the adjusted resolution.

According to an embodiment, the method may comprise displaying a first icon on the first screen. The method may comprise playing a handler on the first screen based on a first user input to the first icon. Identifying the designated area and the non-designated area may include identifying the designated area and the non-designated area on the first screen based on a second user input to the handler.

According to an embodiment, the method may comprise identifying whether there is setting data related to the first application based on a third user input to the first icon. The method may comprise displaying a third screen according to the setting data on the cover display 270 based on a presence of the setting data.

According to an embodiment, the method may comprise identifying whether there is the setting data related to the first application based on the third user input to the first icon. The method may comprise displaying the handler on the first screen based on an absence of the setting data.

According to an embodiment, the method may comprise displaying a first icon and a second icon on the first screen. The method may comprise, based on a first user input to the first icon, displaying a handler on the first screen, and identifying the designated area and the non-designated area on the first screen based on a second user input to the handler. The method may comprise, based on a fourth user input to the second icon, identifying whether there is setting data related to the first application and displaying a third screen according to the setting data on the cover display 270 based on a presence of the setting data.

According to an embodiment, the method may comprise displaying a third icon for displaying the first screen on the second screen. The method may comprise displaying the first screen on the cover display 270 based on a user input to the third icon.

According to an embodiment, the first display may include a notch area. Adjusting the resolution may include adjusting the resolution based on the size of the designated area, the size of the non-designated area, and the size of the notch area.

According to an embodiment, the method may comprise storing setting data related to the adjusted resolution.

According to an embodiment, in the method, the cover display 270 may be disposed on a second surface 212 of a first housing 210 of the electronic device 101. The foldable display 230 of the electronic device 101 may be disposed on a first surface 211 of the first housing 210 of the electronic device 101 and a third surface 221 of a second housing 220 of the electronic device 101. The second surface 212 may face in a direction opposite to the first surface 211. The second housing 220 may include the third surface 221 and a fourth surface 222 facing in a direction opposite to the third surface 221. The first surface 211 and the third surface 221 may contact each other in state in which the first housing 210 and the second housing 220 are folded.

According to an embodiment, in a computer-readable recording medium storing instructions configured to perform at least one operation by a processor 120 of an electronic device 101, the at least one operation may comprise displaying a first screen of a first application on a cover display 270 of the electronic device 101. The at least one operation may comprise identifying a designated area and a non-designated area on the first screen based on a user input on the first screen. The at least one operation may comprise adjusting a resolution where a screen of the first application is to be displayed based on a size of the designated area and a size of the non-designated area. The at least one operation may comprise displaying a second screen of the first application on the cover display 270 at the adjusted resolution.

According to an embodiment, the at least one operation may comprise identifying a position where the screen of the first application is to be displayed based on the size of the designated area and the size of the non-designated area. Displaying the second screen on the cover display 270 may include displaying the second screen at the identified position with the adjusted resolution.

According to an embodiment, the at least one operation may comprise displaying a first icon on the first screen. The at least one operation may comprise playing a handler on the first screen based on a first user input to the first icon. Identifying the designated area and the non-designated area may include identifying the designated area and the non-designated area on the first screen based on a second user input to the handler.

According to an embodiment, the at least one operation may comprise identifying whether there is setting data related to the first application based on a third user input to the first icon. The at least one operation may comprise displaying a third screen according to the setting data on the cover display 270 based on a presence of the setting data.

According to an embodiment, the at least one operation may comprise identifying whether there is the setting data related to the first application based on the third user input to the first icon. The at least one operation may comprise displaying the handler on the first screen based on an absence of the setting data.

According to an embodiment, the at least one operation may comprise displaying a first icon and a second icon on the first screen. The at least one operation may comprise, based on a first user input to the first icon, displaying a handler on the first screen, and identifying the designated area and the non-designated area on the first screen based on a second user input to the handler. The at least one operation may comprise, based on a fourth user input to the second icon, identifying whether there is setting data related to the first application and displaying a third screen according to the setting data on the cover display 270 based on a presence of the setting data.

According to an embodiment, the at least one operation may comprise displaying a third icon for displaying the first screen on the second screen. The at least one operation may comprise displaying the first screen on the cover display 270 based on a user input to the third icon.

According to an embodiment, the first display may include a notch area. Adjusting the resolution may include adjusting the resolution based on the size of the designated area, the size of the non-designated area, and the size of the notch area.

According to an embodiment, the at least one operation may comprise storing setting data related to the adjusted resolution.

According to an embodiment, in the at least one operation, the cover display 270 may be disposed on a second surface 212 of a first housing 210 of the electronic device 101. The foldable display 230 of the electronic device 101 may be disposed on a first surface 211 of the first housing 210 of the electronic device 101 and a third surface 221 of a second housing 220 of the electronic device 101. The second surface 212 may face in a direction opposite to the first surface 211. The second housing 220 may include the third surface 221 and a fourth surface 222 facing in a direction opposite to the third surface 221. The first surface 211 and the third surface 221 may contact each other in state in which the first housing 210 and the second housing 220 are folded.

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program) including one or more instructions that are stored in a storage medium (e.g., internal memory 136 or external memory 138) that is readable by a machine (e.g., the electronic device 101). For example, a processor (e.g., the processor 201) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities. Some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first display;
memory storing one or more computer programs; and
one or more processors communicatively coupled to the first display and the memory,
wherein the one or more computer programs include computer-executable instructions that, when executed by the one or more processors individually or collectively, cause the electronic device to:
display a first screen of a first application on the first display,
identify a designated area and a non-designated area on the first screen based on a user input on the first screen,
adjust a resolution where a screen of the first application is to be displayed based on a size of the designated area and a size of the non-designated area, and
display a second screen of the first application on the first display at the adjusted resolution.

2. The electronic device of claim 1, wherein the one or more computer programs further include computer-executable instructions that, when executed by the one or more processors individually or collectively, cause the electronic device to:
identify a position where the screen of the first application is to be displayed based on the size of the designated area and the size of the non-designated area, and
display the second screen at the identified position at the adjusted resolution.

3. The electronic device of claim 1, wherein the one or more computer programs further include computer-executable instructions that, when executed by the one or more processors individually or collectively, cause the electronic device to:
display a first icon on the first screen,
display a handler on the first screen based on a first user input to the first icon, and
identify the designated area and the non-designated area on the first screen based on a second user input to the handler.

4. The electronic device of claim 3, wherein the one or more computer programs further include computer-executable instructions that, when executed by the one or more processors individually or collectively, cause the electronic device to:
identify whether there is setting data related to the first application based on a third user input to the first icon, and
display a third screen according to the setting data on the first display based on a presence of the setting data.

5. The electronic device of claim 3, wherein the one or more computer programs further include computer-executable instructions that, when executed by the one or more processors individually or collectively, cause the electronic device to:
identify whether there is setting data related to the first application based on a third user input to the first icon; and
display the handler on the first screen based on an absence of the setting data.

6. The electronic device of claim 1, wherein the one or more computer programs further include computer-executable instructions that, when executed by the one or more processors individually or collectively, cause the electronic device to:
display a first icon and a second icon on the first screen,
based on a first user input to the first icon, display a handler on the first screen and identify the designated area and the non-designated area on the first screen based on a second user input to the handler, and
based on a fourth user input to the second icon, identify whether there is setting data related to the first application and display a third screen according to the setting data on the first display based on a presence of the setting data.

7. The electronic device of claim 6, wherein the one or more computer programs further include computer-executable instructions that, when executed by the one or more processors individually or collectively, cause the electronic device to:
display a third icon for displaying the first screen on the second screen, and
display the first screen on the first display based on a user input to the third icon.

8. The electronic device of claim 1,
wherein the first display includes a notch area, and
wherein the one or more computer programs further include computer-executable instructions that, when executed by the one or more processors individually or collectively, cause the electronic device to:
adjust the resolution based on the size of the designated area, the size of the non-designated area, and a size of the notch area.

9. The electronic device of claim 1, wherein the one or more computer programs further include computer-executable instructions that, when executed by the one or more processors individually or collectively, cause the electronic device to:
store, in the memory, setting data related to the adjusted resolution.

10. The electronic device of claim 1, further comprising:
a second display,
wherein the first display is disposed on a first surface of a first housing of the electronic device,
wherein the second display is disposed on a second surface of the first housing and a third surface of a second housing of the electronic device,
wherein the second surface faces in a direction opposite to the first surface,
wherein the second housing includes the third surface and a fourth surface facing in a direction opposite to the third surface, and
wherein the second surface and the third surface contact each other in state in which the first housing and the second housing are folded.

11. A method performed by an electronic device, the method comprising:
displaying, by the electronic device on a first display of the electronic device, a first screen of a first application;
identifying, by the electronic device, a designated area and a non-designated area on the first screen based on a user input on the first screen;
adjusting, by the electronic device, a resolution where a screen of the first application is to be displayed based on a size of the designated area and a size of the non-designated area; and
displaying, by the electronic device on the first display, a second screen of the first application at the adjusted resolution.

12. The method of claim 11, further comprising:
identifying, by the electronic device, a position where the screen of the first application is to be displayed based on the size of the designated area and the size of the non-designated area,
wherein the displaying of the second screen on the first display includes displaying the second screen at the identified position at the adjusted resolution.

13. The method of claim 11, further comprising:
displaying, by the electronic device, a first icon on the first screen; and
displaying, by the electronic device, a handler on the first screen based on a first user input to the first icon,
wherein the identifying of the designated area and the non-designated area includes identifying, by the electronic device, the designated area and the non-designated area on the first screen based on a second user input to the handler.

14. The method of claim 13, further comprising:
identifying, by the electronic device, whether there is setting data related to the first application based on a third user input to the first icon; and
displaying, by the electronic device, a third screen according to the setting data on the first display based on a presence of the setting data.

15. The method of claim 13, further comprising:
identifying, by the electronic device, whether there is setting data related to the first application based on a third user input to the first icon; and
displaying, by the electronic device, the handler on the first screen based on an absence of the setting data.

16. The method of claim 11, further comprising:
displaying, by the electronic device, a first icon and a second icon on the first screen;
based on a first user input to the first icon, displaying, by the electronic device, a handler on the first screen and identifying, by the electronic device, the designated area and the non-designated area on the first screen based on a second user input to the handler; and
based on a fourth user input to the second icon, identifying, by the electronic device, whether there is setting data related to the first application and displaying, by the electronic device, a third screen according to the setting data on the first display based on a presence of the setting data.

17. The method of claim 16, further comprising:
displaying, by the electronic device, a third icon for displaying the first screen on the second screen; and
displaying, by the electronic device, the first screen on the first display based on a user input to the third icon.

18. The method of claim 11,
wherein the first display includes a notch area, and
wherein the method further comprises:
adjusting, by the electronic device, the resolution based on the size of the designated area, the size of the non-designated area, and a size of the notch area.

19. One or more non-transitory computer-readable storage media storing one or more computer programs including computer-executable instructions that, when executed by one or more processors of an electronic device individually or collectively, cause the electronic device to perform operations, the operations comprising:
displaying, by the electronic device on a first display of the electronic device, a first screen of a first application;
identifying, by the electronic device, a designated area and a non-designated area on the first screen based on a user input on the first screen;
adjusting, by the electronic device, a resolution where a screen of the first application is to be displayed based on a size of the designated area and a size of the non-designated area; and
displaying, by the electronic device on the first display, a second screen of the first application at the adjusted resolution.

20. The one or more non-transitory computer-readable storage media of claim 19, the operations further comprising:
identifying, by the electronic device, a position where the screen of the first application is to be displayed based on the size of the designated area and the size of the non-designated area,
wherein the displaying of the second screen on the first display includes displaying the second screen at the identified position at the adjusted resolution.
